(19) United States
(12) Patent Application Publication
(10) Pub. No.: US 2026/0120718 A1
(43) Pub. Date: Apr. 30, 2026

(54) LENGTH-AWARE SPEECH TRANSLATION FOR EDGE VIDEO DUBBING

(71) Applicant: Microsoft Technology Licensing, LLC, Redmond, WA (US)

(72) Inventors: Harveen Singh CHADHA, Karnataka (IN); Aswin Shanmugam SUBRAMANIAN, Redmond, WA (US); Shubham BANSAL, Telangana (IN); Vikas JOSHI, Karnataka (IN); Rupeshkumar Rasiklal MEHTA, Telangana (IN); Jian XUE, Bellevue, WA (US); Jinyu LI, Bellevue, WA (US)

(21) Appl. No.: 19/038,512

(22) Filed: Jan. 27, 2025

(30) Foreign Application Priority Data
Oct. 31, 2024 (IN) 202411083614

(51) Int. Cl. G11B 27/02

(52) U.S. Cl. CPC G11B 27/02

(57) ABSTRACT

This disclosure describes a framework for generating audio translations (e.g., dubbing) of videos, including being performed locally on a client device. For instance, this disclosure describes a video dubbing system that utilizes length-aware speech translation models to provide dynamic audio translations for videos that accurately align with the source audio. In particular, the video dubbing system utilizes length-aware translations to prevent audio misalignment of translated audio, resulting in natural-sounding audio translations. Additionally, the video dubbing system uses techniques such as beam search to efficiently determine dynamic translated audio from multiple versions that align accurately with the source audio. As further described below, the video dubbing system seamlessly provides translated audio phrases in real time that dynamically add or remove words to match the duration of the source audio phrases, resulting in a much more natural dubbing experience.

### CROSS-REFERENCE TO RELATED APPLICATIONS

This application claims priority to Indian Application Number 202411083614, filed on Oct. 31, 2024, the entirety of which is incorporated herein by reference.

### BACKGROUND

As videos are shared with a global audience, it is important to consider the language barriers that exist. Many individuals who speak different languages may want to watch these videos, but they need translations to understand the narrative or other audio content. Unfortunately, not all videos have audio tracks available in different languages. Some video playback systems attempt to provide automatic translations for videos, but these systems face several challenges. For example, many video playback systems struggle with dubbing misalignment. Additionally, many video playback systems suffer from further technical problems, as outlined below.

### BRIEF DESCRIPTION OF THE DRAWINGS

The following detailed description provides specific implementations accompanied by drawings. Additionally, each of the figures listed below includes illustrated examples corresponding to one or more implementations discussed in this disclosure.

FIG. 1 illustrates an overview of the video dubbing system that generates and provides dynamic translated audio for a video using a length-aware speech translation model.

FIG. 2 illustrates a computing environment in which the video dubbing system is implemented.

FIGS. 3A-3B illustrate generating and using a length-aware speech translation model to create multiple translated texts for an audio segment.

FIGS. 4A-4B illustrate supplementing the length-aware speech translation model with beam search to efficiently create the multiple translated texts for an audio segment.

FIGS. 5A-5B illustrate determining a translated audio segment to use for a source audio segment based on duration ratios.

FIG. 6 illustrates a diagram summarizing the full dubbing process.

FIG. 7 illustrates an example series of acts in a computer-implemented method for generating real-time audio translations in one or more videos.

FIG. 8 illustrates example components included within a computer system used to implement the video dubbing system.

### DETAILED DESCRIPTION

This disclosure describes a framework for generating audio translations (e.g., dubbing) of videos, including being performed locally on a client device. For instance, this disclosure describes a video dubbing system that utilizes length-aware speech translation models to provide dynamic audio translations for videos that accurately align with the source audio. In particular, the video dubbing system utilizes length-aware translations to prevent audio misalignment of translated audio, resulting in natural-sounding audio translations. Additionally, the video dubbing system uses techniques such as beam search to efficiently determine dynamic translated audio from multiple versions that align accurately with the source audio. As further described below, the video dubbing system seamlessly provides translated audio phrases in real time that dynamically add or remove words to match the duration of the source audio phrases, resulting in a much more natural dubbing experience.

Implementations of the present disclosure provide benefits and solve problems in the art with systems, computer-readable media, and computer-implemented methods by using a video dubbing system to provide dynamic length-aware speech translations on a client device. As described below, the video dubbing system utilizes a length-aware speech translation model with beam search on a client device to provide dynamic audio translations that match the pace and progress of the source audio.

To elaborate on how the video dubbing system generates real-time audio translations in one or more videos on a client device, in various implementations, the video dubbing system receives a video dubbing request to provide audio in a second language for a video in a first language. For example, the video dubbing system generates a plurality of translated audio segments in the second language for an audio segment (e.g., a source audio segment) of the video (e.g., utilizing a length-aware speech translation model). Each of the plurality of translated audio segments is of a different duration. In addition, the video dubbing system compares the different durations of the translated audio segments to the duration of the source audio segment. The video dubbing system also selects a translated audio segment from the translated audio segments based on the translated audio segment having a duration that is within a threshold of the duration of the source audio segment. Upon selecting the translated audio segment, the video dubbing system provides the selected translated audio segment with the video.

As mentioned, current video playback systems face several technical challenges. For example, many existing systems face challenges due to misalignment between source and translated audio in video dubbing such as when the translated audio is either shorter or longer than the source audio. To elaborate, various video playback systems that provide speech translation capabilities generate translations without considering the duration and length of the source audio. These models often produce translations that are either shorter or longer than the source audio, leading to synchronization issues in dubbed videos. This issue is further complicated by text-to-speech models generating speech at different cadences.

Some video playback systems attempt to address this by manually adjusting the speed of the translated audio or by using post-processing techniques to align the audio with the video. However, these methods can compromise the quality of the translation and result in undesirable dubbing experiences. For example, if the translated audio is twice the duration of the source audio, the video playback systems need to play the translated audio at double speed (or frequently pause the video image) to provide video dubbing. Furthermore, when the speed between the dubbed audio and the source audio differs, the playback experience becomes very unnatural (e.g., the lips of speakers and sometimes the speakers themselves are misaligned).

In addition, many current systems face challenges due to the need for contextual understanding and translation processing delays. Offline video dubbing approaches, which rely on the full audio track, are often impractical as websites may not provide the full or complete audio or may require users to wait for several minutes. Additionally, many current systems do not address timing discrepancies, resulting in potential misalignment between video playback and translated audio. These are just a few examples of the issues that exist with current video translation services.

As another example, many current systems that provide real-time dubbing face challenges due to the need for contextual understanding and delays caused by translation processing. These systems suffer from implementation constraints of client devices, which cause lagging and/or audio misalignment during video playback. In some instances, current video playback systems utilize an offline dubbing approach. However, these approaches are largely impractical as they rely on the full audio track, which websites often do not provide. As a result, these current systems take a significant amount of time to obtain audio, causing users to wait for several minutes for a short video. The problem compounds with larger videos.

As mentioned above, many current video playback systems do not account for timing discrepancies. This leads to potential misalignment between the video playback and the translated audio. Consequently, the video becomes confusing as the translated words do not correspond with the video content being shown.

In contrast, as described in this disclosure, the video dubbing system delivers several significant technical benefits in terms of improved efficiency, accuracy, and flexibility compared to current video playback systems. Furthermore, the video dubbing system provides several practical applications that address problems related to improving the playback of videos with length-aware speech translation models, beam search, and real-time translated audio processing on a client device.

To illustrate, the video dubbing system provides length-aware translated audio segments that match the duration of source audio segments. To generate the length-aware translated audio segments, the video dubbing system creates multiple text translation variations of a source audio segment. Furthermore, the video dubbing system converts the translations into audio segments of different durations using a text-to-speech model and then selects the translated audio segment that has a similar duration to the source audio segment. By using length-aware translated audio segments, the video dubbing system improves dubbing accuracy by preventing misalignment of the translated audio.

In various implementations, the video dubbing system utilizes a length-aware speech translation model to generate translated segments that semantically match the content of the source audio segment. To improve accuracy and efficiency, the video dubbing system may also add length-aware beam search to the length-aware speech translation model to allow multiple translated segments to be generated concurrently.

As a note, while this disclosure focuses on providing real-time audio translation (e.g., dubbing) for a video while minimizing time misalignment, the same or similar principles can be applied to translated text. In various implementations, the video dubbing system provides the translated text it creates as part of the audio translation process with the video at the correct corresponding time (e.g., without time misalignment). In some instances, the video dubbing system provides translated text (e.g., subtitles or closed captioning) without providing the audio translation.

As illustrated in the foregoing discussion, this disclosure utilizes a variety of terms to describe the features and advantages of one or more implementations described. As an example, the term “video” refers to digital content that includes one or more images in a sequence coupled with audio in a first language. Often, a video includes a sequence of images accompanied by music or audio that includes words spoken or sung in at least a first language. In various implementations, a video includes an image track and an audio track. The audio track may include one or more buffered audio segments or portions.

As another example, the term “audio segment” refers to a specific portion of an audio recording, defined by its start and end points. In some instances, an audio segment corresponds to a video segment. In this document, unless otherwise stated, the term “audio segment” refers to source audio in a first language, and the term “translated audio segment” refers to an audio segment in a second language corresponding to the requested dubbed language.

As an example, the term “dubbing” refers to applying some or all of an audio translation track to the images of a video. In various implementations, dubbing includes layering or mixing a second audio translation track over a first audio track in a different language. In some instances, dubbing includes adding new dialogue (e.g., translated audio) to the audio track of a video that has already been filmed.

As an example, the term “machine-learning model” refers to a computer model or computer representation that can be trained (e.g., optimized) based on inputs to approximate unknown functions. For instance, a machine-learning model can include (but is not limited to) an autoencoder model, a distortion classification model, a neural network (e.g., a convolutional neural network or deep learning model), a decision tree (e.g., a gradient-boosted decision tree), a linear regression model, a logistic regression model, or a combination of these models. For example, the length-aware speech translation model is a machine learning model and beam search is a machine learning model add-on and/or algorithm.

As another example, the term “neural network” refers to a machine learning model comprising interconnected artificial neurons that communicate and learn to approximate complex functions, generating outputs based on multiple inputs provided to the model. For instance, a neural network includes an algorithm (or set of algorithms) that employs deep learning techniques and utilizes training data to adjust the parameters of the network and model high-level abstractions in data. Various types of neural networks exist, such as convolutional neural networks (CNNs), residual learning neural networks, recurrent neural networks (RNNs), generative neural networks, generative adversarial networks (GANs), and single-shot detection (SSD) networks.

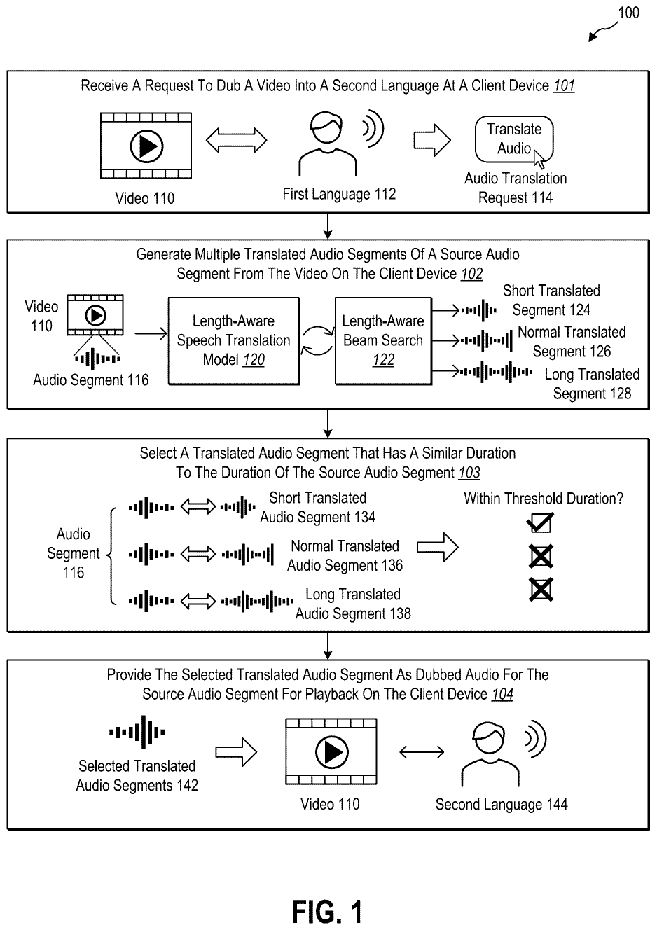

Implementation examples and details of the video dubbing system are discussed in connection with the accompanying figures, which are described next. For example, FIG. 1 illustrates an overview of the video dubbing system that generates and provides dynamic translated audio for a video using a length-aware speech translation model according to some implementations. In particular, FIG. 1 includes a series of acts 100 for providing video with dubbed translated audio in real time, performed by the video dubbing system.

As shown, the series of acts 100 includes act 101 of receiving a request to dub a video into a second language on a client device. For instance, an application on the client device, such as a media player or a web browser, plays a video 110 to a user in response to detecting a selection to play the video. In some instances, the application on the client device detects an audio translation request 114 to play audio for the video in a language different from the language included in the video. For example, the video is in Spanish (e.g., a first language 112) and the client device detects a selection to play the video in French (e.g., a second language).

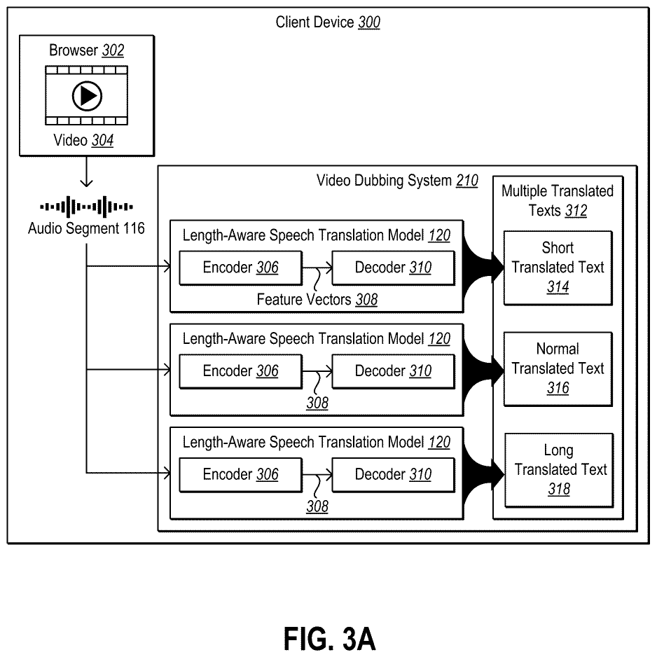

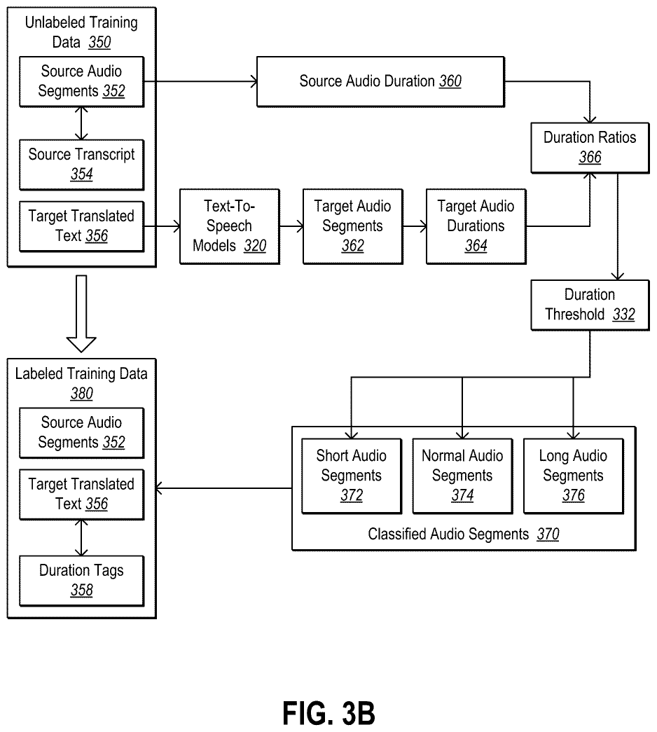

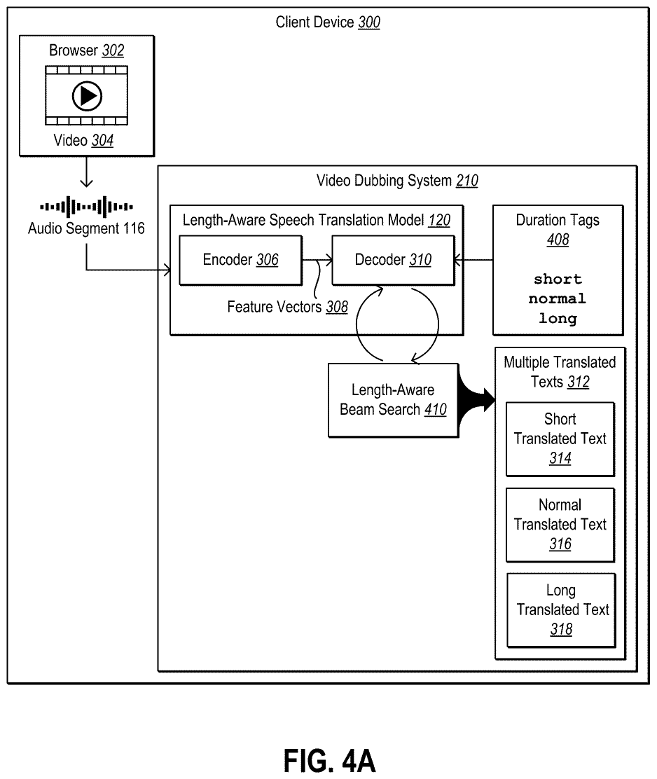

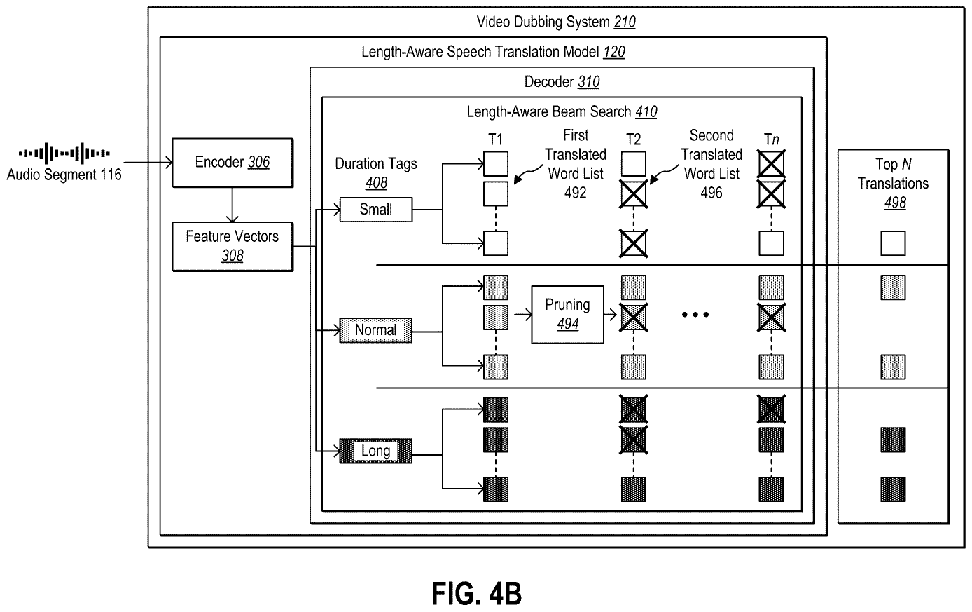

Act 102 includes generating multiple translated audio segments of a source audio segment from the video on the client device. For example, the video dubbing system identifies an audio segment 116 from the video 110 to be translated. In addition, the video dubbing system utilizes a length-aware speech translation model 120 and/or length-aware beam search 122 to generate a short translated segment 124, a normal translated segment 126, and a long translated segment 128 of the audio segment 116 (note, additional/different duration segments can be generated, including extra-short and extra-long). As mentioned, the various translated segments are different versions with varying lengths of the audio segment 116. Additional details about generating translated segments are provided in connection with FIGS. 3A-3B and 4A-4B.

Act 103 includes selecting a translated audio segment that has a duration similar to the duration of the source audio segment. In various implementations, the video dubbing system generates translated audio segments from the translated segments (e.g., a short translated audio segment 134, a normal translated audio segment 136, and a long translated audio segment 138).

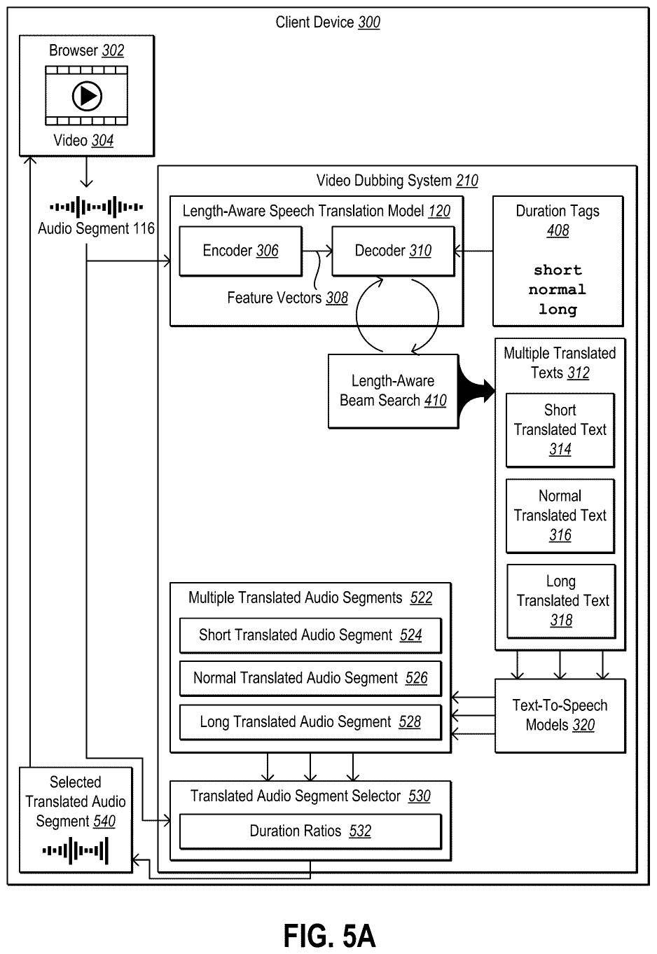

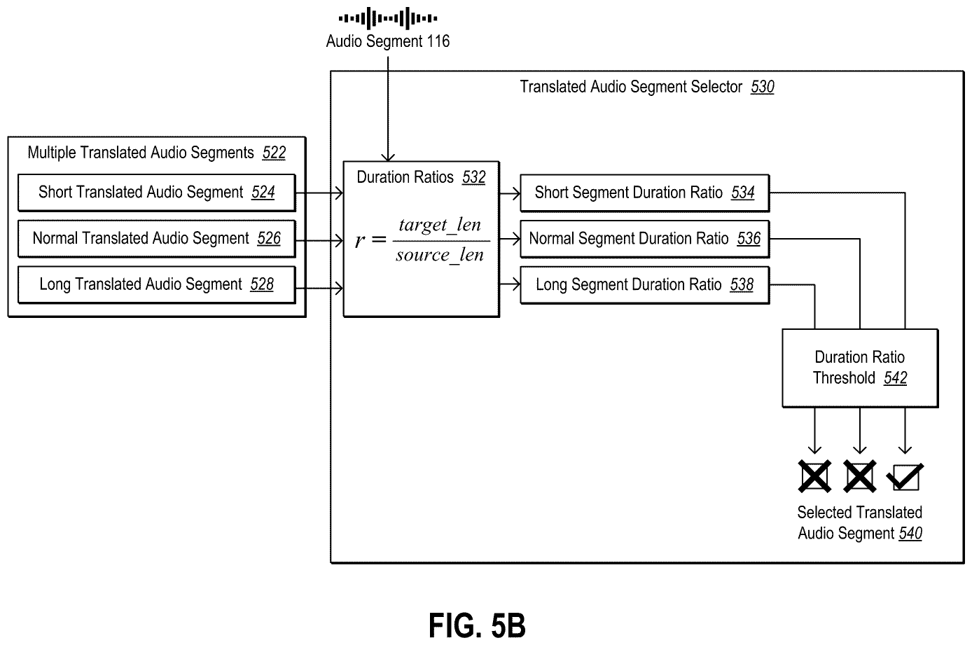

In addition, the video dubbing system compares the duration of the translated audio segments to the duration of the audio segment 116. In some instances, the video dubbing system generates duration ratios. Using a duration threshold, the video dubbing system selects one of the translated audio segments with a duration similar to the source audio segment. Additional details about duration ratios and selecting a translated audio segment are provided in connection with FIGS. 5A-5B.

Act 104 includes providing the selected translated audio segment as dubbed audio for the source audio segment for playback on the client device. For instance, once the video dubbing system generates and selects a translated audio segment for the source audio segment, it can store the selected translated audio segment 142 in a dubbed audio buffer and/or provide it to an application playing the video on the client device with timestamps corresponding to the original audio. In response, the application plays the video with the audio in the second language 144 dubbed over or in place of the original audio. By doing so, the video dubbing system efficiently provides real-time audio translations that accurately align with the content of the video and are processed locally on a client device.

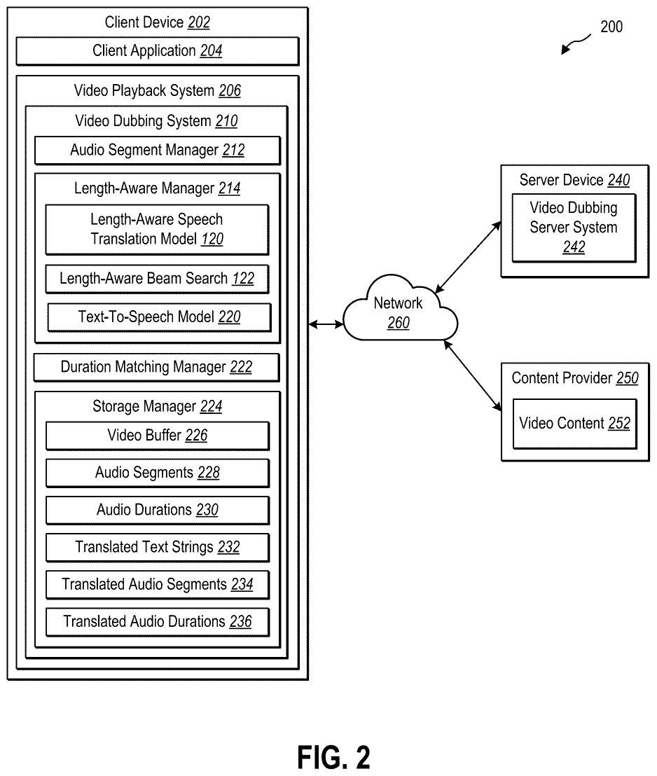

With a general overview in place, additional details are provided regarding the components, features, and elements of the video dubbing system. To illustrate, FIG. 2 shows an example computing environment in which the video dubbing system is implemented according to some implementations. In particular, FIG. 2 illustrates an example of a computing environment 200 with various computing devices, including a client device 202 with a video dubbing system 210, a server device 240 with a video dubbing server system 242, and a content provider 250 with video content 252. The computing devices in the computing environment 200 are connected via a network 260.

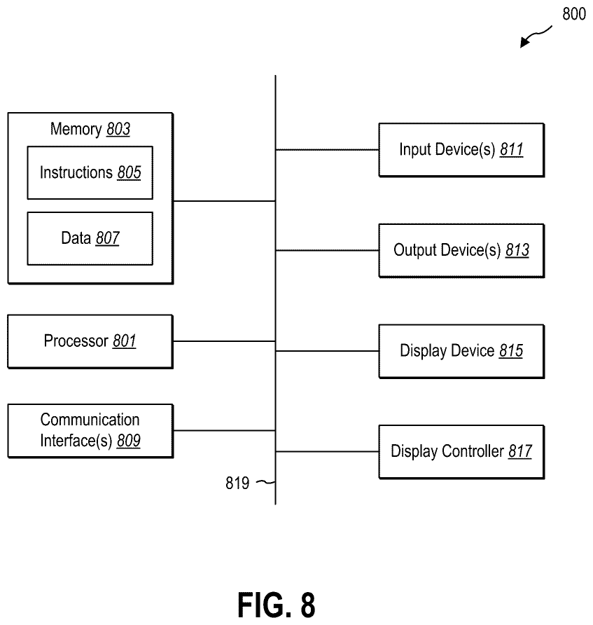

While FIG. 2 shows example arrangements and configurations of the video dubbing system 210 within the computing environment 200, other arrangements and configurations are possible. Additionally, further details regarding computing devices are provided below in connection with FIG. 8, which also includes additional details regarding networks, such as the network 260 shown.

As shown, the computing environment 200 includes a client device 202. As described further below, the client device 202 may correspond to a personal computer (PC) or another personal device, including portable devices that include multithreaded processing capabilities. In various implementations, the client device 202 is associated with a user, such as a user who watches videos. In some implementations, the user requests that a video be played with audio dubbed in another language. For example, the user requests to play a video in a language not included in the original video.

The client device 202 includes a client application 204. In some implementations, the client application 204 represents a software application located on the client device 202, such as a web browser, a media player, or a content consumption application. In various implementations, the client application 204 obtains and provides (e.g., plays) videos to a user.

The client device 202 also includes the video playback system 206. In various implementations, the video playback system 206 is implemented within the client application 204. For example, the video playback system 206 is a feature, plugin, or extension of the client application 204.

As shown, the video playback system 206 implements the video dubbing system 210. In some implementations, the video dubbing system 210 is located apart from the video playback system 206. In some implementations, the client application 204 communicates with the video playback system 206 and/or the video dubbing system 210 to request and receive real-time audio dubbing of videos played by the client application 204.

In various implementations, including the illustrated implementation, the video dubbing system 210 includes various components and elements implemented in hardware and/or software. For example, the video dubbing system 210 includes an audio segment manager 212, a length-aware segment manager 214, a duration matching manager 222, and a storage manager 224. As shown, the length-aware segment manager 214 includes a length-aware speech translation model 120, a length-aware beam search 122, and a text-to-speech model 220. The storage manager 224 includes a video buffer 226, audio segments 228, audio durations 230, translated text strings 232, translated audio segments 234, and translated audio durations 236, among other data used by the video dubbing system 210.

To elaborate, in various implementations, the audio segment manager 212 directs the generation of translated audio segments 234 for a video. In various implementations, the audio segment manager 212 manages various data conversion models to process and convert the original audio into translated audio for dubbing. For example, the audio segment manager 212 utilizes the length-aware speech translation model 120 to generate translated text strings 232 of different lengths from audio segments 228 stored in the video buffer 226. The audio segment manager 212 also uses the length-aware beam search 122 to improve the efficiency of generating the translated text strings 232. In addition, the audio segment manager 212 utilizes the text-to-speech model 220 to generate translated audio segments 234 from the translated text strings 232.

As mentioned above, the video dubbing system 210 includes the duration matching manager 222, which facilitates selecting a translated audio segment for an audio segment from the source audio. For example, the duration matching manager 222 compares audio durations 230 with audio durations 236 to determine or identify a translated audio segment that is similar in duration to the audio segment. In various implementations, the duration matching manager 222 determines duration ratios and/or uses a duration threshold in selecting a translated audio segment.

As shown, the computing environment 200 includes the server device 240 having the video dubbing server system 242. In various implementations, some or all of the video dubbing system 210 is located on the server device 240 (e.g., the video dubbing server system 242). If partially located on the server device 240, the video dubbing server system 242 works with the video dubbing system 210 on the client device 202 to provide real-time length-aware audio dubbing of videos. For example, the video dubbing server system 242 uses multithreaded processing to generate and provide the translated audio segments 234 to the client device 202 for video playback with dubbed audio.

Additionally, the computing environment 200 includes the content provider 250. As shown, the content provider 250 includes video content 252, such as videos provided to the client device 202 for user viewing. In various implementations, the content provider 250 represents multiple content providers that provide and distribute video to client devices. In some instances, while the client device 202 receives video content 252 from remote sources, such as the content provider 250 the client device 202 translates locally stored video.

Turning to the next figures, FIGS. 3A-3B illustrate generating and using a length-aware speech translation model to create multiple translated texts for an audio segment according to some implementations. In particular, FIG. 3A shows a block diagram for generating translated text segments using a length-aware speech translation model, and FIG. 3B shows an example process for generating training data for the length-aware speech translation model.

As shown, FIG. 3A includes a client device 300 with a browser 302 (e.g., a client application) and the video dubbing system 210. The video dubbing system 210 includes multiple instances of the length-aware speech translation model 120, which generates multiple translated texts 312.

As also shown, the browser 302 includes a video 304. For example, the video 304 is provided as a stream from a content provider to play within the browser 302. In various implementations, the browser 302 includes one or more selectable options for requesting that the video 304 be translated into another language (e.g., video dubbing). In some implementations, the video dubbing system 210 is integrated within the browser 302, as mentioned above. For example, the video dubbing system 210 is a feature or plugin of the browser 302.

In one or more instances, the client device 300 receives or detects a request to play the audio of the video 304 in a different language (e.g., a request to provide real-time dubbing of the video 304). Because the video 304 does not include an audio track in the requested language, the video dubbing system 210 generates and provides the requested language in real time as dubbed audio.

In response to the real-time video dubbing request, the video dubbing system 210 begins receiving audio segments of the video 304. As shown, the video dubbing system 210 receives an audio segment 116. For each audio segment, the video dubbing system 210 may perform a set of operations to convert the audio segment into a translated audio segment. Accordingly, the example shown in FIG. 3A for the audio segment 116 may be repeated for other audio segments of the video 304.

In various implementations, audio segments are generated using an audio buffer and a segmentation model. For example, audio in the source language from the video is rendered and captured in an audio buffer (not shown). The audio buffer can use a moving or sliding window of audio to capture and store audio from the video 304 and/or a content provider. In some instances, the browser 302 or the video dubbing system 210 renders the audio.

To elaborate, many content providers provide an initial portion of a video to build up a buffer, then stream the remaining portions at a slower or actual pace (e.g., collect a 30-second burst of data in 3-5 seconds, followed by 1-second bursts as the sliding window 612 progresses). As mentioned above, then makes offline processing infeasible, as it takes a significant amount of time to download a video, and bandwidth is unnecessarily used on video that a user will not consume (e.g., because many users do not watch entire videos and it wastes bandwidth to download complete videos).

Accordingly, as shown, the video dubbing system 210 may use a sliding window (e.g., striding window) to obtain audio data from the video as it streams in. The sliding window acts as a streaming buffer to collect audio data in an audio buffer. By using the sliding window the video dubbing system 210 collects an initial amount of audio data and continues to incrementally add more audio data.

Next, the video dubbing system 210 may use an audio segmentation model (not shown) to generate audio segments from the rendered audio. The audio segmentation model may generate audio segments of 5-20 seconds. In some implementations, the audio segmentation model uses a segmentation algorithm to segment the audio based on time duration (e.g., 5-second segments). In various implementations, the audio segmentation model is a machine learning model and/or neural network that generates segments based on suitable points of segmentation (e.g., breaks, pauses, or silence) in the audio within a time range (e.g., 5-20 seconds).

To elaborate, in various implementations, the video dubbing system 210 performs segmentation based on a combination of voice activity detection (VAD). For instance, the audio segmentation model uses a VAD-based algorithm to generate audio segments by determining natural pauses or breaks in the audio (after a minimum time occurs (e.g., 3 or 5 seconds)), as described above. However, if a maximum time threshold elapses without generating an audio segment, the video dubbing system 210 may force the creation of an audio segment.

The video dubbing system 210 may receive the audio segment 116 from the video 304 (e.g., via an audio buffer and audio segmentation model). Upon receiving the audio segment 116, the video dubbing system 210 generates multiple translated texts 312 using multiple instances of the length-aware speech translation model 120. In particular, the length-aware speech translation model 120 is a speech-to-text translation model that converts audio in a first language (e.g., the source language) into translated text in a second language.

As shown, the length-aware speech translation model 120 can be an autoencoder model that includes an encoder 306 and a decoder 310. For example, the encoder 306 generates feature vectors 308 from the audio segment 116 and decodes the feature vectors 308 in the decoder 310 to generate the multiple translated texts 312.

In some implementations, a length-aware speech translation model is trained to generate a specific translated text length. For instance, one length-aware speech translation model is fine-tuned to generate a normal translated text 316 (e.g., a direct translation) from the audio segment 116, another length-aware speech translation model is fine-tuned to generate a short translated text 314 (e.g., a translation with fewer words), and another is fine-tuned to generate the long translated text 318 (e.g., a translation with additional words) (note, additional/different lengths can be generated, including extra-short and extra-long). In some implementations, the video dubbing system 210 provides duration labels or tags to the length-aware speech translation model 120, often via the decoder 310, which instructs the model regarding the desired duration.

As an example, suppose the video dubbing system 210 receives an audio segment 116 that states the Spanish phrase, “La conferencia fue un gran éxito, con expertos de todo el mundo compartiendo sus últimas investigaciones y conocimientos.” In translating the audio segment 116 to English, the length-aware speech translation model 120 may generate a normal translated text, “The conference was successful with experts sharing insights.” Note, that the length of this normal (or direct) translation is much shorter than the original content. In addition, the length-aware speech translation model 120 may generate a short translated text, “The conference was insightful,” and a long translated text, “The conference was a great success, with experts from around the world sharing their latest research and insights.”

In various implementations, the length-aware speech translation model 120 can take the form of a different architecture type that generates multiple translated texts 312. For instance, the length-aware speech translation model 120 is a transducer machine learning model that generates translated audio segments in the translated language in near-real-time. For example, the length-aware speech translation model 120 is a generative artificial intelligence (AI) model, such as a small generative AI model, that generates the multiple translated texts 312.

In some instances, the client device 300 lacks sufficient resources to maintain and run multiple speech translation models. For example, the client device 300 lacks processing power or resources to maintain additional speech translation models. In these instances, rather than using multiple model instances, the video dubbing system 210 uses a single model with multiple passes utilizing different duration tags to generate the multiple translated texts 312. In some cases, the video dubbing system 210 encodes the audio segment 116 once and performs decoding for each translated text length. However, using multiple instances of models or model portions may render real-time dubbing infeasible due to delays. Addressing these issues is described further in connection with FIGS. 4A-4B.

As mentioned above, FIG. 3B provides additional details about generating training data for the length-aware speech translation model. In particular, FIG. 3B corresponds to generating training data used to train a length-aware speech translation model. Then, using this training data, the video dubbing system 210 generates and fine-tunes a length-aware speech translation model to generate length-aware translated segment texts.

As shown, FIG. 3B includes unlabeled training data 350 (e.g., a variable duration dataset), which includes source audio segments 352 in a first or source language as well as the target translated text 356 in a second language that are translations of the source audio segments 352. In some instances, the source audio segments 352 have been transcribed into text in the same language, shown as the source transcript 354. In some implementations, the source audio segments 352 include audio segments in various languages (other than the second language). Indeed, the source audio segments 352 can flexibly include numerous languages to be dubbed into the target translated language.

In many implementations, the target translated text 356 includes translations of corresponding source audio segments. For example, some of the target translated text 356 are direct translations. In various instances, some of the target translated text 356 includes short, long, or alternative versions (e.g., extra-short and extra-long) of the source audio segments 352. In some cases, a source audio segment is associated with multiple target translated text versions.

As shown, the video dubbing system 210 determines source audio durations 360 for the source audio segments 352. In particular, the video dubbing system 210 determines the length of time (e.g., seconds and/or milliseconds) for each of the source audio segments 352 to play. Similarly, the video dubbing system 210 determines target audio durations 364 for the target translated text 356.

To elaborate, the video dubbing system 210 first generates translated audio segments 362 from the target translated text 356 using text-to-speech models 320. The text-to-speech models 320 may include multiple model versions that convert text into audio. These models may vary by voice type, speech rhythm, flow, cadence, and other factors that affect the duration of a translated audio segment. In addition to generating the translated audio segments 362 from the target translated text 356 using the text-to-speech models 320, in some instances, the video dubbing system 210 also generates one or more source-based audio segments from the source transcript 354 and determines their respective durations, which are used as one or more of the source audio durations 360.

Upon obtaining the source audio durations 360 and the audio durations 364, the video dubbing system 210 can determine duration ratios 366. For example, for a source audio segment and a target translated text, the video dubbing system 210 determines the pair's audio duration. In one or more implementations, the video dubbing system 210 determines an audio duration ratio as ratio (r)=(target_length/source_length) or vice versa. In some implementations, the video dubbing system 210 determines a duration difference metric, which is the difference in time between a source audio segment and a corresponding target audio segment.

Based on the duration ratios (or another duration metric), the video dubbing system 210 can classify the target translated text 356 as short audio segments 372, normal audio segments 374, long audio segments 376, or another duration classification (e.g., extra-short and extra-long). For example, in various implementations, the video dubbing system 210 utilizes the duration threshold 332 to classify each target translated text.

To elaborate, in some instances, the duration threshold 332 indicates a delta value that indicates whether the duration of a translated audio segment is short, normal, long, or another duration. For example, for a duration threshold 332 of 0.1 or 10%, the video dubbing system 210 classifies a translated audio segment as a short audio segment if it is 10% shorter in time than the corresponding source audio duration, a long audio segment if it is 10% longer in time than the corresponding source audio duration, and a normal audio segment if it falls within the 10% threshold.

In some implementations, when comparing duration ratios, the duration threshold is mapped to a classification scheme to determine the classification. For example, the classification scheme indicates a short audio segment if |ratio (r)|<(1−threshold), a long audio segment if |r|>(1+threshold), and a normal audio segment if (1−threshold)<|r|<(1+threshold).

The video dubbing system 210 can apply different duration ratios. In some implementations, the duration ratio is based on the translated language. Additionally, the video dubbing system 210 can use additional classification types by using multiple duration thresholds to organize the target translated text 356.

Using the classified audio segments 370, the video dubbing system 210 can generate ground truth labels for the target translated text 356. As shown, the video dubbing system 210 updates the unlabeled training data 350 with the classified audio segments 370 to generate labeled training data 380, where the target translated text 356 is associated with duration tags 358.

With the labeled training data 380 generated, the video dubbing system 210 can train a length-aware speech translation model. For example, the video dubbing system 210 utilizes the labeled training data 380 with supervisory end-to-end learning and loss function optimization to fine-tune a length-aware speech translation model to generate translated audio segments of different durations from a source audio segment. The video dubbing system 210 provides a length-aware speech translation model with a source audio segment and a duration tag and teaches the length-aware speech translation model to generate an audio segment translated into the second language as the desired length and/or duration.

As mentioned above, the video dubbing system 210 determines audio durations for both the source and translated audio segments. The video dubbing system 210 can use different approaches to determine duration. For example, in one or more implementations, the video dubbing system 210 determines duration based on audio duration, such as the actual speech time in an audio segment. While audio provides a realistic representation, the variance in speaking style, speed, language, and other speech characteristics can make using audio duration difficult to consistently model.

As another example, the video dubbing system 210 determines duration based on character length. For example, the video dubbing system 210 applies a character count to each audio segment to determine their respective duration. While gathering character data is straightforward, character length may not be directly proportional to the duration. Additionally, comparing characters from different alphabets can pose challenges (e.g., while many languages use Roman characters, some written languages such as Chinese, Japanese, and Korean use a different written alphabet and writing system, which complicates character count comparisons).

As a further example, the video dubbing system 210 determines duration based on phonetic length. For example, the video dubbing system 210 generates a phonetic sentence for each audio segment and determines the audio durations based on the phonetic sentences. Although a phonetic generation model may be needed to generate a phonetic sentence for each audio segment, using phonetic sentences allows the video dubbing system 210 to use accurate, repeatable, and universal (e.g., language-agnostic) audio durations.

As noted above, the video dubbing system 210 may need to run a length-aware speech translation model multiple times for the same source audio segment to generate the short, normal, and long translated segments (or other segment durations). To improve the speed and efficiency of generating the multiple translated texts, the video dubbing system 210 may add beam search functionality to the length-aware speech translation model 120. To illustrate, FIG. 4A-4B show supplementing the length-aware speech translation model with beam search to efficiently create the multiple translated texts for an audio segment according to some implementations. In particular, FIG. 4A shows a block diagram of efficiently generating translated text segments using a length-aware speech translation model with beam search, and FIG. 3B shows an example process for performing a beam search to generate multiple translated texts.

FIG. 4A extends the concepts introduced in FIG. 3A. Notably, the video dubbing system 210 in FIG. 4A includes a single instance of the length-aware speech translation model 120 and adds duration tags 408 and a length-aware beam search 410. By utilizing the length-aware beam search 410, the video dubbing system 210 is able to run a single pass through the model to generate the multiple translated texts 312. By doing so, the video dubbing system 210 improves the efficiency of the client device 300 and reduces processing time, allowing the video dubbing system 210 to operate in real time.

As mentioned above, the video dubbing system 210 receives the audio segment 116 and generates the multiple translated texts 312 using the length-aware speech translation model 120. As shown in FIG. 4A, the video dubbing system 210 provides duration tags 408 in a set to the length-aware speech translation model 120 (e.g., the decoder 310), which instructs the model to generate at least one translated text for each provided duration tag.

Furthermore, the length-aware speech translation model 120 provides output classification probabilities (e.g., translated text tokens or words) to the length-aware beam search 410, which uses modified beam search functionality to efficiently identify text translations for multiple duration tags in the same pass of the model. Additionally, the length-aware beam search 410 introduces variation in the beam search results.

To elaborate, FIG. 4B shows an example of the length-aware speech translation model l120 operating with a modified beam search function. For ease of explanation, the length-aware beam search 410 is located within the decoder 310. However, in some instances, the length-aware beam search 410 is added onto the decoder 310 or is separate from the decoder 310.

As shown, the video dubbing system 210 provides the audio segment 116 to the encoder 306, which generates feature vectors 308. The feature vectors 308 are then provided to the decoder 310. Duration tags 408 are also provided to the decoder 310, as mentioned above. As shown, the duration tags 408 include small, normal, and long durations For context, in a typical beam search, the decoder begins by processing the first token in a series of tokens representing an encoded audio segment. The decoder determines probability scores for each translated word or phrase representing the first token. The beam search keeps the top-n results and prunes out the remaining possible words (e.g., selects the top five words with the highest probability scores out of 50,000 words).

The top-n words are then provided back to the decoder and used as part of decoding the second token. The decoder determines probability scores for each translated word or phrase representing the second token and follows each of the top-n results, respectively. For each of the top-n results of the first word, the top-n results of the second word are selected while the rest are pruned. For example, for the first selection of the first word, the decoder selects the top 5 second words to follow the first selected first word in the translated text. For the second selected first word, the decoder selects the top 5 second words to follow the second selection of the first word. Each of these is provided back to the decoder to process the third token, and so on. This beam search process continues for all of the tokens in the series to form sets of translated texts. Generally, the top-ranked translated text is selected as the final translation for the audio segment 116.

In length-aware beam search, the typical beam search actions are modified to generate a diverse set of translated texts. To illustrate, when processing the first token, the length-aware beam search 410 instructs the decoder to generate different durations of translated texts. As shown, at Token 1 (T1), the decoder 310 generates a first translated word list 492 that includes probability scores for each word. The first translated word list 492 includes words for each of the duration tags 408.

As shown, the video dubbing system 210 prunes 494 the first translated word list 492 down to a set of the top-n first words (e.g., the top-5 selected words for the first word in the translated text). However, as part of the modification, pruning maintains a minimum number of words (e.g., at least one) for each duration tag. The result of pruning is shown in T2 of FIG. 4B. By requiring at least one text string of each duration to survive pruning at each stage, the video dubbing system 210 can generate multiple translated texts 312 of different durations in a single model pass.

Next, for each of the first translated words that survived pruning, the decoder generates a second translated word list 496. Accordingly, the decoder 310 generates at least one second translated word list for each of the duration tags 408. The length-aware beam search continues for all the tokens until a set of top-n translations 498 is generated. As shown, the set of top-n translations 498 includes at least one translation from each duration tag. The video dubbing system 210 can select the highest ranking translation for each duration tag to serve as the multiple translated texts 312.

As mentioned above, FIGS. 5A-5B provide additional details about duration ratios and selecting a translated audio segment. For instance, FIGS. 5A-5B illustrate determining a translated audio segment to use for a source audio segment based on duration ratios according to some implementations. In particular, FIG. 5A shows a block diagram for determining a length-aware translated audio segment, and FIG. 5B shows a process for selecting the translated audio segment that aligns with a source audio segment.

FIG. 5A extends the concepts described in FIG. 3A and FIG. 4A. As shown, the video dubbing system 210 includes additional components such as the text-to-speech models 320, which generate multiple translated audio segments, and a translated audio segment selector 530 for determining a selected translated audio segment 540.

As shown, the multiple translated texts 312 generated by the length-aware speech translation model 120 using the length-aware beam search 410 for the audio segment 116 are provided to the text-to-speech models 320. A text-to-speech model generates multiple translated audio segments 522 from the multiple translated texts 312. In particular, the short translated text 314 is converted to a short translated audio segment 524, the normal translated text 316 is converted to a normal translated audio segment 526, and the long translated text 318 is converted to a long translated audio segment 528.

Depending on the text-to-speech model and settings used (which may be based on user preference), the same translated text may vary in duration when converted into translated audio. Accordingly, the video dubbing system 210 determines the durations of the various translated audio segments after they have been created into audio segments. Then, using the audio segment durations, the video dubbing system 210 can select one of the multiple translated audio segments 522 to return for the audio segment 116.

In various implementations, the video dubbing system 210 generates duration ratios 532 for the multiple translated audio segments 522. Based on the duration ratios 532, the video dubbing system 210 may use a translated audio segment selector 530 to select the multiple translated audio segments 522 that closely or best align with the audio segment 116. The video dubbing system 210 then provides the selected translated audio segment 540 based on the browser 302 to be used for dubbing the audio segment 116.

In various instances, the video dubbing system 210 selects the multiple translated audio segments 522 that most closely match the duration of the audio segment 116. By doing so, the video dubbing system 210 can select a translated audio segment that closely aligns with the source audio. Furthermore, the selected translated audio segment 540 does not need to be unnaturally sped up or slowed down to fit within the allocated time in the video (e.g., it can play without modifying the playback speed because it has a similar duration). As a result, the dubbing experience is enhanced through a more accurate alignment of translated audio during video playback, leading to a more natural experience.

In some instances, the video dubbing system 210 provides the selected translated audio segment 540 to a dubbed audio buffer. Translated audio from the dubbed audio buffer is provided to the browser 302 to play in the video 304 as a dubbed audio track in the requested language. For instance, if the video dubbing system 210 is keeping ahead of the video playback, it uses the dubbed audio buffer to ensure continuous video playback without needing to pause for the translated audio. By doing so, the video dubbing system 210 plays the video with translated audio in real time, regardless of video length with no unwanted pauses or buffering breaks.

As mentioned above, FIG. 5B shows a process for selecting the translated audio segment that aligns with a source audio segment. As shown, the video dubbing system 210 generates duration ratios 532 from the multiple translated audio segments 522 by comparing each translated audio segment with the audio segment 116. As mentioned above, in some instances, the video dubbing system 210 determines an audio duration ratio as ratio (r)=(target_length/source_length) or vice versa. As shown, the video dubbing system 210 generates a short segment duration ratio 534 for the short translated audio segment 524, a normal segment duration ratio 536 for the normal translated audio segment 526, and a long segment duration ratio 538 for the long translated audio segment 528.

The video dubbing system 210 then compares each of the duration ratios to a duration ratio threshold 542. In some instances, the duration ratio threshold 542 indicates an acceptable duration difference between a translated audio segment and the audio segment 116, where the two audio segments are considered similar or comparable in length. The duration ratio threshold 542 may be expressed as a number or percentage. In various cases, the video dubbing system 210 determines that the duration ratio threshold 542 is met or satisfied when a translated audio segment duration ratio (r) is within a threshold range (e.g., (1−threshold)<|r|<(1+threshold)). For example, a duration ratio threshold 542 of 0.1 indicates that translated audio segments with a duration ratio over 0.9 and under 1.1 match the audio segment 116. Duration ratio values falling outside the range indicate non-matches.

As shown, the video dubbing system 210 compares the short segment duration ratio 534, the normal segment duration ratio 536, and the long segment duration ratio 538 to the duration ratio threshold 542. The results indicate that the short segment duration ratio 534 is selected as the selected translated audio segment 540. If multiple translated audio segments meet the duration threshold, the video dubbing system 210 can select the translated audio segment with the smallest duration difference from the source audio segment (e.g., the closest matching duration).

In some instances, the video dubbing system 210 determines a duration metric, such as the time difference between the durations of a translated audio segment and the audio segment. In these instances, the video dubbing system 210 may compare the duration metric of each translated audio segment to a duration threshold, which may be a relative or absolute length of time (e.g., 15% or 0.5 seconds). If a translated audio segment has a duration metric within the duration threshold, it may be chosen as the selected translated audio segment 540.

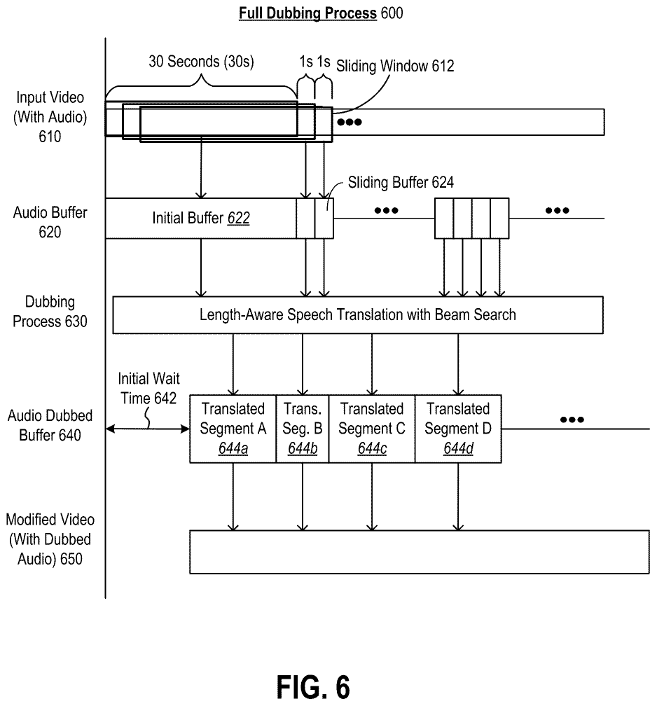

FIG. 6 illustrates a diagram summarizing the full dubbing process according to some implementations. FIG. 6 also includes components and operations (shown in rows) associated with the video dubbing system 210 performing a full dubbing process 600. Additionally, the full dubbing process 600 progresses from left to right.

As shown, the full dubbing process 600 includes an input video 610 and an audio buffer 620, as described above. For example, the video dubbing system 210 captures a video stream that includes receiving an initial bulk portion of audio content (e.g., 30 seconds of content), stored in an initial buffer 622, followed by receiving small incremental portions of content (e.g., 1 second of content), stored in a sliding buffer 624. As described above, the video dubbing system 210 may use a sliding window 612 to receive the input video 610 in a video stream.

In addition, the full dubbing process 600 includes the dubbing process 630, which corresponds to the video dubbing system 210 performing length-aware speech translation with beam search. For example, the dubbing process 630 includes segmenting audio, generating multiple translated texts (in a second language) via length-aware speech translation and beam search, creating multiple translated audio segments (in the second language) using text-to-speech models, determining duration ratios for each translated audio segment, and selecting a translated audio segment that closely or best aligns with a source audio segment.

As shown, the dubbing process 630 generates translated audio segments and provides them to the audio dubbed buffer 640. In particular, after an initial wait time 642 during which the video dubbing system 210 begins to receive and generate translated audio segments, the video dubbing system 210 starts providing translated audio segments to the audio dubbed buffer 640, shown as Translated Segment A 644a, Translated Segment B 644b, Translated Segment C 644c, and Translated Segment D 644d.

In various implementations, the audio dubbed buffer 640 is used to provide translated audio in the second language to the browser or application playing the video to include the dubbed audio. For example, once the initial wait time 642 elapses, the video dubbing system 210 may continuously provide translated audio from the audio dubbed buffer 640 until the video ends or until the user stops playback.

To further illustrate, FIG. 6 includes the modified video 650 with the dubbed audio. As shown, the modified video 650 buffers for the initial wait time 642, then begins playing. Indeed, when requesting the automatic translation of the audio for a video on the fly, the video dubbing system 210 briefly buffers for a few seconds (e.g., 5-10 seconds) while processing the first batch of translated audio segments and selecting a translated audio segment that closely or best aligns with the source audio segments. The video dubbing system 210 can then provide real time, continuous translated audio to the video player without any pause between batches until the video ends or playback is stopped.

In some implementations, the modified video 650 replaces the original audio in the first language with the translated audio in the second requested language. In one or more implementations, the modified video 650 adds the translated audio to the video. For example, the modified video 650 includes a quieter version of the original audio in the first language and a normal or louder version of the translated audio in the second language, which is heard over the original audio track.

In some implementations, the video dubbing system 210 does not modify the video but provides the translated audio in segments to the video player. For example, the video dubbing system 210 provides the translated audio to a browser that audio dubs the translated audio over the original audio during video playback. Furthermore, the video dubbing system 210 may provide segments of the translated audio to the browser as they become available in the audio dubbed buffer 640.

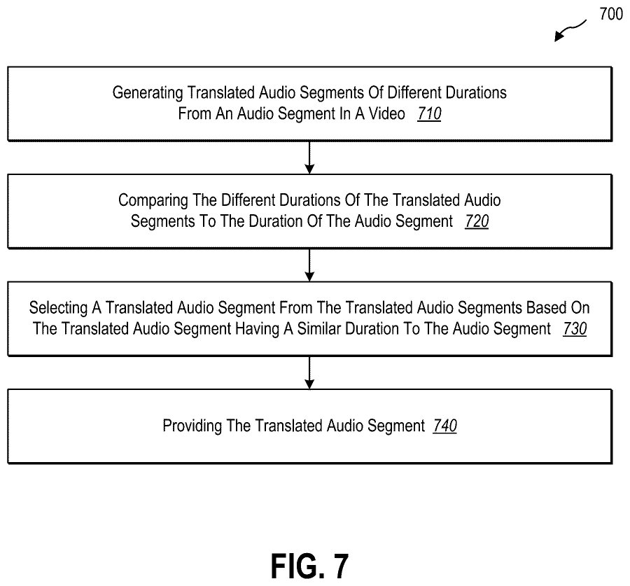

Turning now to FIG. 7, which illustrates an example series of acts in a computer-implemented method for generating real-time audio translations in one or more videos according to some implementations. While FIG. 7 illustrates acts according to one or more implementations, alternative implementations may omit, add, reorder, and/or modify any of the acts shown.

The acts in FIG. 7 can be performed as part of a method (e.g., a computer-implemented method). Alternatively, a computer-readable medium can include instructions that, when executed by a processing system with a processor, cause a computing device to perform the acts in FIG. 7. In some implementations, a system (e.g., a processing system comprising a processor) can perform the acts in FIG. 7. For example, the system includes a processing system and a computer memory including instructions that, when executed by the processing system, cause the system to perform various actions, operations, or steps.

To illustrate, in FIG. 7, the series of acts 700 includes act 710 of generating translated audio segments of different durations from an audio segment in a video. For instance, in example implementations, act 710 involves generating, from an audio segment in a first language corresponding to a video, translated audio segments of different durations in a second language.

In various implementations, act 710 includes generating, from an audio segment in a first language corresponding to a video, translated audio segments of different durations in a second language utilizing a length-aware speech translation model that generates multiple translated outputs of different durations for an audio input.

In one or more implementations, the length-aware speech translation model includes an autoencoder neural network model that encodes audio inputs from multiple languages into feature vectors and decodes the feature vectors into translated text segments of different lengths in the second language. In some instances, act 710 includes generating the translated audio segments using translated text segments of different lengths in the second language with a text-to-speech model. In various implementations, act 710 includes utilizing length-aware beam search on outputs of the length-aware speech translation model to concurrently determine the translated audio segments of different durations. In various implementations, each of the different durations includes at least one translated audio segment.

In some implementations, in act 710, generating the translated audio segments of different durations in the second language further includes providing different duration tags to the length-aware speech translation model corresponding to the different durations. In various implementations, the different duration tags cause the length-aware speech translation model to generate the different durations for the translated audio segments. In some implementations, the different duration tags include a short duration tag, a normal duration tag, and a long duration tag. In various implementations, the translated audio segments of different durations in the second language include a short-duration audio segment, a normal-duration audio segment, and a long-duration audio segment. In one or more implementations, the different duration tags are applied at the decoder of the length-aware speech translation model.

In various implementations, act 710 includes generating a variable duration dataset (e.g., labeled training data) that maps input audio segments in one or more languages to corresponding sets of outputs in the second language. In some instances, an output set for an audio segment input includes multiple outputs of different durations that have the same semantic meaning as the audio segment input. In various implementations, the variable duration dataset is used for training the length-aware speech translation model. In various implementations, generating the translated audio segments of different durations in the second language includes utilizing a length-aware speech translation model that generates multiple translated outputs of different durations for an audio input.

In one or more implementations, generating the translated audio segments of different durations in the second language includes utilizing a length-aware speech translation model that generates multiple translated outputs of different durations for an audio segment input, and the length-aware speech translation model includes a transducer model that generates translated audio segments in the second language in near-real-time. In some implementations, act 710 includes using length-aware beam search with outputs of the length-aware speech translation model to concurrently generate the translated audio segments of different durations in the second language.

As further shown, the series of acts 700 includes act 720 of comparing the different durations of the translated audio segments to the duration of the audio segment. For instance, in example implementations, act 720 involves comparing the different durations of the translated audio segments in the second language to the duration of the audio segment in the first language. In one or more implementations, act 720 includes comparing the different durations of the translated audio segments in the second language to the duration of the audio segment in the first language by generating respective duration ratios between the audio segment and the translated audio segments.

In some implementations, the different durations are determined based on the phonetic lengths of the translated audio segments in the second language. In various instances, the different durations are determined based on the character length of the translated audio segments in the second language. In various instances, comparing the different durations of the translated audio segments in the second language to the duration of the audio segment in the first language includes generating duration ratios between the audio segment and the translated audio segments.

As further shown, the series of acts 700 includes act 730 of selecting a translated audio segment from the translated audio segments based on the translated audio segment having a similar duration to the audio segment. For instance, in some implementations, act 730 involves selecting a first translated audio segment from the translated audio segments in the second language based on the first translated audio segment having a duration that is within a threshold of the duration of the audio segment in the first language. In various implementations, act 730 includes selecting a first translated audio segment from the translated audio segments in the second language based on the first translated audio segment having a duration ratio that meets a threshold duration value.

In some implementations, act 730 includes selecting the first translated audio segment by determining that the duration of the first translated audio segment is within a threshold duration of the audio segment and determining that one or more durations of one or more additional translated audio segments is/are not within the threshold duration of the audio segment. In some instances, selecting the first translated audio segment from the translated audio segments in the second language is based on the first translated audio segment having a duration ratio that meets a threshold duration value.

Furthermore, the series of acts 700 includes act 740 of providing the translated audio segment. For instance, in example implementations, act 740 involves providing the first translated audio segment to be played with the video. In some implementations, the first translated audio segment with the video includes dubbing the audio segment of the video during, in place of, or with the first translated audio segment (or replacing the audio segment of the video with the first translated audio segment) without modifying the playback speed of the first translated audio segment. In one or more implementations, the video includes multiple audio segments in the first language, and multiple translated audio segments in the second language are generated for each of the multiple audio segments, and for each of the multiple audio segments, a corresponding translated audio segment with the closest matching duration is selected to dub over the audio segment in the video.

FIG. 8 illustrates certain components that may be included within a computer system 800. The computer system 800 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single-or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU) and may cause computer-implemented instructions to be performed. Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates according to an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For clarity, the various buses are illustrated in FIG. 8 as a bus system 819.

Furthermore, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that fall within the meaning and range of equivalency of the claims are to be embraced within their scope.

What is claimed is:

1. A computer-implemented method for generating real-time audio translations in one or more videos on a client device, comprising:
generating, on the client device and from an audio segment in a first language corresponding to a video, translated audio segments of different durations in a second language utilizing a length-aware speech translation model that generates multiple translated outputs of different durations for an audio input;
comparing, on the client device, the different durations of the translated audio segments in the second language to a duration of the audio segment in the first language by generating respective duration ratios between the audio segment and the translated audio segments;
selecting a first translated audio segment from the translated audio segments in the second language based on the first translated audio segment having a duration ratio that meets a threshold duration value; and
providing the first translated audio segment to be played with the video.

2. The computer-implemented method of claim 1, wherein the length-aware speech translation model includes an autoencoder neural network model that:
encodes audio inputs from multiple languages into feature vectors; and
decodes the feature vectors into translated text segments of different lengths in the second language.

3. The computer-implemented method of claim 2, wherein generating the translated audio segments of different durations in the second language further includes generating the translated audio segments using translated text segments of different lengths in the second language with a text-to-speech model.

4. The computer-implemented method of claim 1, wherein generating the translated audio segments of different durations in the second language further includes providing different duration tags to the length-aware speech translation model corresponding to the different durations, wherein the different duration tags cause the length-aware speech translation model to generate the different durations for the translated audio segments.

5. The computer-implemented method of claim 4, wherein:
the different duration tags include a short duration tag, a normal duration tag, and a long duration tag; and
the translated audio segments of different durations in the second language include a short-duration audio segment, a normal-duration audio segment, and a long-duration audio segment.

6. The computer-implemented method of claim 4, wherein the different duration tags are applied at a decoder of the length-aware speech translation model.

7. The computer-implemented method of claim 1, wherein:
generating the translated audio segments of different durations in the second language further includes utilizing length-aware beam search on outputs of the length-aware speech translation model to concurrently determine the translated audio segments of different durations; and
each of the different durations includes at least one translated audio segment.

8. The computer-implemented method of claim 1, wherein the different durations are determined based on phonetic lengths of the translated audio segments in the second language.

9. The computer-implemented method of claim 1, wherein the different durations are determined based on character length of the translated audio segments in the second language.

10. The computer-implemented method of claim 1, wherein selecting the first translated audio segment includes:
determining that the duration of the first translated audio segment is within a threshold duration of the audio segment; and
determining that one or more durations of one or more additional translated audio segments is not within the threshold duration of the audio segment.

11. The computer-implemented method of claim 1, wherein the first translated audio segment with the video includes dubbing the audio segment of the video during the first translated audio segment without modifying playback speed of the first translated audio segment.

12. The computer-implemented method of claim 1, further comprising:
generating a variable duration dataset that maps input audio segments in one or more languages to corresponding sets of outputs in the second language, wherein an output set for an audio segment input includes multiple outputs of different durations that have a same semantic meaning as the audio segment input; and
training the length-aware speech translation model with the variable duration dataset.

13. The computer-implemented method of claim 1, wherein:
the video includes multiple audio segments in the first language;
multiple translated audio segments in the second language are generated for each of the multiple audio segments; and
for each of the multiple audio segments, a corresponding translated audio segment with a closest matching duration is selected to dub over the audio segment in the video.

14. A system comprising:
a client device having a processor; and
a computer memory including instructions that, when executed by the client device, cause the client device to carry out operations comprising:
generating, on the client device and from an audio segment in a first language corresponding to a video, translated audio segments of different durations in a second language utilizing a length-aware speech translation model that generates multiple translated outputs of different durations for an audio input;
comparing, on the client device, the different durations of the translated audio segments in the second language to a duration of the audio segment in the first language by generating respective duration ratios between the audio segment and the translated audio segments;
selecting a first translated audio segment from the translated audio segments in the second language based on the first translated audio segment having a duration ratio that is within a threshold duration value; and
providing the first translated audio segment to be played with the video.

15. The system of claim 14, wherein generating the translated audio segments of different durations in the second language includes utilizing a length-aware speech translation model that generates multiple translated outputs of different durations for an audio input.

16. The system of claim 14, wherein comparing the different durations of the translated audio segments in the second language to the duration of the audio segment in the first language includes generating duration ratios between the audio segment and the translated audio segments.

17. The system of claim 16, wherein selecting the first translated audio segment from the translated audio segments in the second language is based on the first translated audio segment having a duration ratio that meets a threshold duration value.

18. A computer-implemented method for generating real-time audio translations in one or more videos, comprising:
generating, on the client device and from an audio segment in a first language corresponding to a video, translated audio segments of different durations in a second language;
comparing, on the client device, the different durations of the translated audio segments in the second language to a duration of the audio segment in the first language;
selecting a first translated audio segment from the translated audio segments in the second language based on the first translated audio segment having a duration that is within a threshold of the duration of the audio segment in the first language; and
providing the first translated audio segment with the video.

19. The computer-implemented method of claim 18, wherein:
generating the translated audio segments of different durations in the second language includes utilizing a length-aware speech translation model that generates multiple translated outputs of different durations for an audio input; and
the length-aware speech translation model includes a transducer model that generates translated audio segments in the second language in near-real-time.

20. The computer-implemented method of claim 19, further comprising using length-aware beam search with outputs of the length-aware speech translation model to concurrently generate the translated audio segments of different durations in the second language.
